(19) United States
(12) Patent Application Publication
(10) Pub. No.: US 2011/0063749 A1
(43) Pub. Date: Mar. 17, 2011

(54) DUAL-PORT HARD-DISK STORAGE DEVICE

(76) Inventor: TZU-CHEN LIU, Keelung City (TW)

(21) Appl. No.: 12/558,608

(22) Filed: Sep. 14, 2009

(51) Int. Cl. G11B 15/18

(52) U.S. Cl. 360/71

(57) ABSTRACT

The hard-disk storage device contains a USB jack, an internal SATA jack, a signal processor, an electronic controller, and a 2.5″ SATA HDD. The USB jack is connected to a corresponding USB jack on a personal computer so as to be used as an external removable storage device. The internal SATA jack is connected to a corresponding SATA jack inside the personal computer so as to be used as a fixed internal storage device. The signal processor is to convert USB signals to and from the personal computer into corresponding SATA signals. The SATA signals are then delivered from and to the 2.5″ SATA HDD through the electronic controller. The electronic controller is to convey SATA signals between the personal computer and the 2.5″ SATA HDD and to obstruct signals from the USB jack to the 2.5″ SATA HDD so as to prevent their interference.

### TECHNICAL FIELD OF THE INVENTION

The present invention generally relates to hard-disk storage devices, and more particularly to a hard-disk storage device having a USB port and an internal SATA port.

### DESCRIPTION OF THE PRIOR ART

Currently, a hard-disk storage device is either fixedly installed inside a computer via, for example, an internal Serial Advanced Technology Attachment (INT SATA) connection or detachably and externally connected to a computer via, for example, a Universal Serial Bus (USB) connection. When a hard-disk storage device is configured to support both INT SATA and USB connections so that the hard-disk storage device could be flexibly applied in either way as required, there is an interference problem. For example, if the hard-disk storage device is connected to a computer by the INT SATA connection, its signal communication with the computer would be affected by interfering current originated from the hard-disk storage device's USB part even though the hard-disk storage is not concurrently connected to any computer via its USB port.

### SUMMARY OF THE INVENTION

The present invention therefore provides a novel hard-disk storage device which contains a USB jack, an internal SATA jack, a signal processor, an electronic controller, and a 2.5″ SATA HDD. The USB jack is connected to a corresponding USB jack on a personal computer so that the hard-disk storage device is used as an external removable storage device. The USB connection is for both signal communication and drawing power from the personal computer. The internal SATA jack is connected to a corresponding SATA jack inside the personal computer so that the hard-disk storage device is used as a fixed internal storage device. The SATA connection is also for signal communication and drawing power from the personal computer.

The signal processor is to convert USB signals to and from the personal computer into corresponding SATA signals. The SATA signals are then delivered from and to the 2.5″ SATA HDD through the electronic controller. The electronic controller is to convey SATA signals between the personal computer and the 2.5″ SATA HDD. In the mean time, the electronic controller obstructs signals from the USB jack to the 2.5″ SATA HDD so as to prevent their interference to the 2.5″ SATA HDD.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic block diagram showing the various components of a hard-disk storage device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

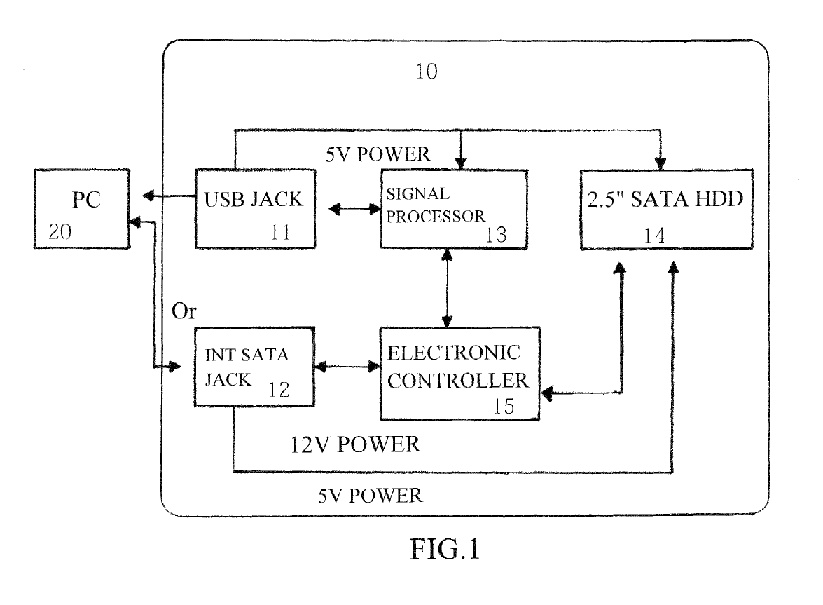

As illustrated in FIG. 1, a hard-disk storage device 10 according to the present invention contains a USB jack 11 and an INT SATA jack 12. The hard-disk storage device 10 therefore could be externally and detachably connected to a personal computer (PC) 20 by bridging a USB cable between the USB jack 11 and a corresponding USB jack on the PC 20. The hard-disk storage device 10 further contains a 2.5″ SATA hard-disk drive (HDD) 14, and a signal processor 13. Through the foregoing USB connection, the hard-disk storage device 10 draws a 5-volt power from the PC 20 to drive the signal processor 13, and the 2.5″ SATA HDD. On the other hand, signals transmitted over the USB connection are converted by signal processor 13 into corresponding SATA signals delivered to/from an electronic controller 15. The electronic controller 15 in turn controls the 2.5″ SATA HDD accordingly.

As illustrated in FIG. 1, the hard-disk storage device 10 could also be fixedly installed inside the PC 20 by connecting the INT SATA jack 12 to a corresponding SATA jack in the PC 20. The electronic controller 15, when conveying signals between the 2.5″ SATA HDD 14 and the PC 20, prevents any signal from the USB jack 11 from reaching the 2.5″ SATA HDD 14 so that the 2.5″ SATA HDD 14 is not interfered.

As shown in FIG. 1, through the foregoing SATA connection, the hard-disk storage device 10 draws a 5-volt power and a 12-volt power from the PC 20. The 12-volt power is for the electronic controller 15 to cut down USB signals' reaching the 2.5″ SATA HDD 14. The 5-volt power is to drive the signal processor 13 and the 2.5″ SATA HDD 14, respectively. By the obstruction of the electronic controller 15, the signals between the INT SATA jack 12 and the electronic controller 15 are not interfered by the USB jack 11. Therefore, the storage device 10 could be successfully used either as a removable external storage device by a USB connection or as a fixed internal storage device by an internal SATA connection.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A hard-disk storage device comprising a USB jack, an internal SATA jack, a signal processor, an electronic controller, and a 2.5″ SATA HDD wherein
said USB jack is capable of being connected to a corresponding USB jack on a personal computer for both signal communication and power drawing so that said hard-disk storage device is used as said personal computer's external removable storage device;
said internal SATA jack is capable of being connected to a corresponding SATA jack inside a personal computer for both signal communication and power drawing so that said hard-disk storage device is used as said personal computer's fixed internal storage device;
said signal processor is to convert USB signals between said personal computer and said USB jack into SATA signals, and said SATA signals are then conveyed to and from said 2.5″ SATA HDD through said electronic controller; and
said electronic controller is to convey SATA signals between said personal computer and said 2.5″ SATA HDD and to obstruct signals from said USB jack to said 2.5″ SATA HDD so as to prevent interference thereof.
